(19) United States
(12) Patent Application Publication
(10) Pub. No.: US 2017/0031162 A1
(43) Pub. Date: Feb. 2, 2017

(54) DISPLAY DEVICE FOR VEHICLE AND DISPLAY METHOD FOR VEHICLE

(71) Applicant: HONDA MOTOR CO., LTD., Tokyo (JP)

(72) Inventors: Yasuhiro Konishi, Sakai-shi (JP); Kotaro Higuchi, Wako-shi (JP)

(73) Assignee: HONDA MOTOR CO., LTD., Tokyo (JP)

(21) Appl. No.: 15/221,205

(22) Filed: Jul. 27, 2016

(30) Foreign Application Priority Data
Jul. 28, 2015 (JP) 2015-148870

(51) Int. Cl. G02B 27/01

(52) U.S. Cl. CPC G02B 27/0101

(57) ABSTRACT

A display device for a vehicle includes: a design display part for generating multiple split designs into which a single continuous design is split; and multiple virtual image display parts for respectively displaying virtual images of corresponding split designs. Each virtual image display part displays, among the multiple split designs, a near side split design which is a split design on the near side in the sight line direction of the driver, in such a manner that it continues into a far side split design which is a split design on the far side in the sight line direction of the driver, from the near side.

### TECHNICAL FIELD

The present invention relates to a display device for a vehicle, and a display method for a vehicle.

### BACKGROUND OF THE INVENTION

A HUD (Head-Up Display) has been developed in which driving information is superimposed on the field of view of a driver, and displayed on the windshield of a vehicle. Driving information includes speed and information related to car navigation, for example. In a HUD, a projected image is projected on a front window of a vehicle, and the observer views an image as a combination of a background image having penetrated the front window, and a virtual image formed by the image projected on the front window. Here, the projected image is a two-dimensional image, and the viewed image is also a two-dimensional image.

In recent years, there has been a need for a HUD that allows the observer to sense the depth of an image having depth. An image having depth is a turn-by-turn image indicating the traveling direction at an intersection with an image such as an arrow icon, or a compass image indicating the traveling direction together with an image of a compass, for example.

As a HUD that allows the observer to sense depth, a display device has been proposed in which three different images projected on a liquid crystal panel are displayed simultaneously by use of two semitransparent mirrors and a single mirror, to display a three-dimensional image. Here, the three different images are: a first image including a speedometer and a tachometer; a second image including a fuel gauge, a water temperature gauge, and various indicators and warning lamps; and a third image is an image of digital display of the vehicle speed (see Patent Document 1, for example).

### DESCRIPTION OF THE PRIOR ART

### Patent Document

[Patent Document 1] Japanese Patent Application Publication No. 2005-119471

However, since the technique described in Patent Document 1 uses two semitransparent mirrors and a single mirror to display multiple different images simultaneously, it cannot display images such as a turn-by-turn image and a compass image with a sense of depth.

### SUMMARY OF THE INVENTION

The present invention has been made in view of the foregoing, and aims to provide a display device for a vehicle and a display method for a vehicle, which can display an image having depth, so that an observer can sense the depth.

(1) To achieve the above objective, a display device for a vehicle according to an aspect of the present invention includes: a design display part (a device which performs image generation and display functions) for generating multiple split designs into which a single continuous design is split; and multiple virtual image display parts (parts of a projector) for respectively projecting and displaying virtual images of corresponding split designs on a plane of projection in a vehicle, and each virtual image display part displays, among the multiple split designs, a near side split design which is a split design on the near side in a view from a driver to the plane of projection which defines a sight line direction of the driver, in such a manner that it continues into a far side split design which is a split design on the far side in the sight line direction of the driver, from the near side.

(2) Also, in a display device for a vehicle according to an aspect of the present invention, the multiple split designs may include n (n is two or a larger integer) split designs; the design display part may include a liquid crystal display having n display areas; the near side split design may be displayed in a first display area of the n display areas; and the far side split design may be displayed in an n-th display area of the n display areas.

(3) Also, in a display device for a vehicle according to an aspect of the present invention, the multiple virtual image display parts may include a single mirror and (n−1) semitransparent mirrors; the mirror may reflect the far side split design displayed in the n-th display area; and a first semitransparent mirror, which is closest to the plane of projection on which the multiple split designs are projected among the (n−1) semitransparent mirrors, may transmit the far side split design reflected by the mirror, and reflect the near side split design displayed in the first display area, to project the images on the plane of projection.

(4) Also, in a display device for a vehicle according to an aspect of the present invention, the multiple split designs may include three split designs; the design display part may include a liquid crystal display having three display areas; the near side split design may be displayed in a first display area of the three display areas; the far side split design may be displayed in a third display area of the three display areas; an intermediate split design, which is a split design between the near side split design and the far side split design, may be displayed in a second display area of the three display areas; the multiple virtual image display parts may include a single mirror, a first semitransparent mirror, and a second semitransparent mirror; the first semitransparent mirror, the second semitransparent mirror, and the mirror may be arranged in this order from the side closer to a plane of projection on which the multiple split designs are projected; the mirror may reflect the far side split design displayed in the third display area; the second semitransparent mirror may transmit the far side split design reflected by the mirror, and reflect the intermediate split design displayed in the second display area; and the first semitransparent mirror may transmit the far side split design transmitted by the second semitransparent mirror and the intermediate split design reflected by the second semitransparent mirror, and reflect the nearside split design displayed in the third display area, to project the images on the plane of projection.

(5) Also, in a display device for a vehicle according to an aspect of the present invention, a configuration may be adopted in which the multiple split designs do not have a line continuous between adjacent split designs.

(6) Also, in a display device for a vehicle according to an aspect of the present invention, the near side split design may be a partial design selected by the driver from among the multiple split designs.

(7) To achieve the above objective, a display method for a vehicle according to an aspect of the present invention includes: a design display step by a design display part, for generating multiple split designs into which a single continuous design is split; and multiple virtual image display steps by a virtual image display part, for respectively displaying virtual images of corresponding split designs, among the split designs split by the design display part, and in each virtual image display step, a near side split design which is a split design on the near side in a sight line direction of a driver, among the multiple split designs, is displayed in such a manner that it continues into a far side split design which is a split design on the far side in the sight line direction of the driver, from the near side.

According to (1) to (4) and (7), an image having depth can be displayed, so that an observer can sense the depth.

According to (5), since adjacent split designs do not have lines continuous therebetween, a continuous image such as a vertical line is less likely to appear shifted in the horizontal direction, even when accuracy in part attachment is insufficient, or when there has been a secular change, for example.

According to (6), an image of a part selected by the driver can be displayed in the foremost position, and therefore the part selected by the driver can be displayed in an accentuated manner.

### BRIEF DESCRIPTION OF THE DRAWINGS

FIG. 1 is a schematic configuration diagram of a display device for a vehicle according to a first embodiment.

FIG. 2 is a cross-sectional view of a liquid crystal panel, mirror, second semitransparent mirror, and first semitransparent mirror according to the first embodiment, and is a diagram for describing reflected light and transmitted light.

FIG. 3 is a diagram showing an example of a display image, split display image, virtual image, and image viewed by the driver, according to the first embodiment.

FIG. 4 is a diagram showing another example of the display image, split display image, virtual image, and image viewed by the driver according to the first embodiment.

FIG. 5 is a flowchart of processing performed by the display device for a vehicle according to the first embodiment.

FIG. 6 is a diagram showing an example of how a continuous image such as a vertical line appears shifted in the horizontal direction, when the driver views multiple superimposed display images.

FIG. 7 is a diagram showing examples of an image viewed by the driver, based on a display image having lines and images that are discontinuous in split areas, according to a second embodiment.

FIG. 8 is a schematic configuration diagram of a display device for a vehicle according to the second embodiment.

FIG. 9 is a diagram showing an example of a display image, image displayed on a liquid crystal panel, virtual image, and image viewed by the driver, according to the second embodiment.

FIG. 10 is a diagram showing another example of the display image, image displayed on a liquid crystal panel, virtual image, and image viewed by the driver, according to the second embodiment.

FIG. 11 is a flowchart of processing performed by the display device for a vehicle according to the second embodiment.

FIG. 12 is a diagram showing an example of how each of the image displayed on a liquid crystal panel, virtual image, and image viewed by the driver according to the second embodiment varies over time.

FIG. 13 is a schematic configuration diagram of a display device for a vehicle according to a third embodiment.

FIG. 14 is an example of a display image of a telephone book and image viewed by the driver, according to the third embodiment.

FIG. 15 is a diagram showing an example of how a display image is split according to a part selected by the driver, according to the third embodiment.

FIG. 16 is a diagram showing an example of how a warning is displayed in three split areas of a liquid crystal panel, according to an embodiment.

### DETAILED DESCRIPTION OF THE INVENTION

Hereinafter, embodiments of the present invention will be described with reference to the drawings. The following description will be given by using a HUD (Head-Up Display) installed in a vehicle, as an example of a display device for a vehicle.

### First Embodiment

First, a configuration of a display device for a vehicle 1 will be described.

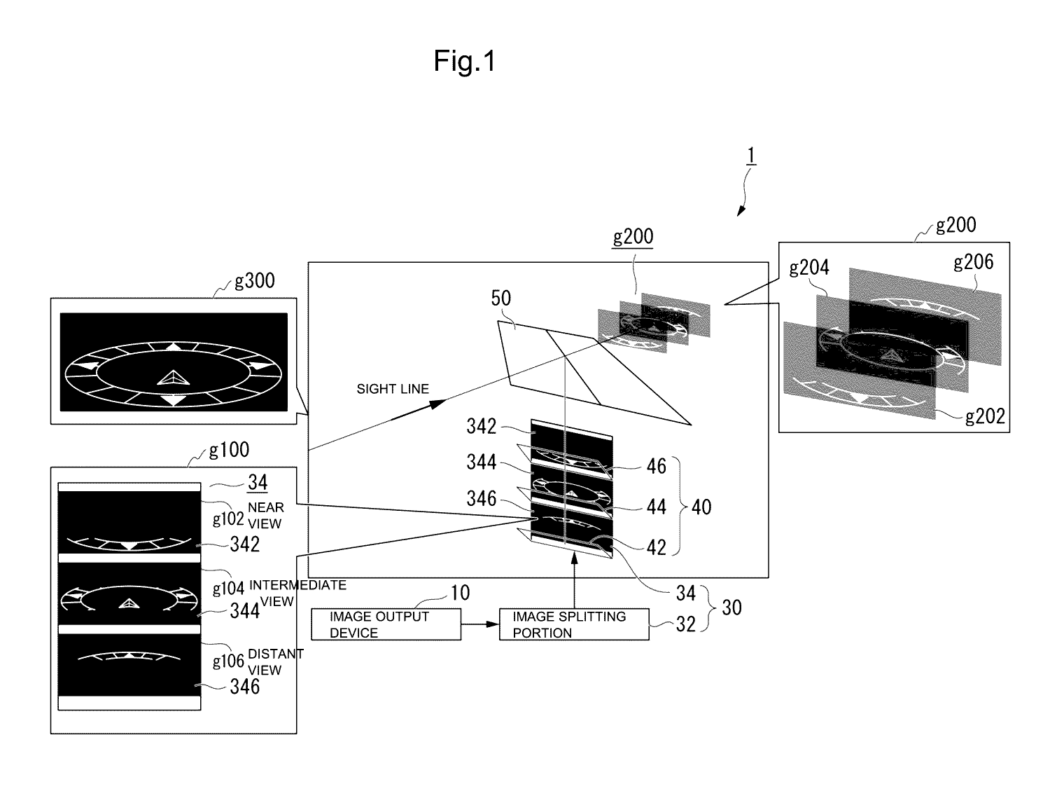

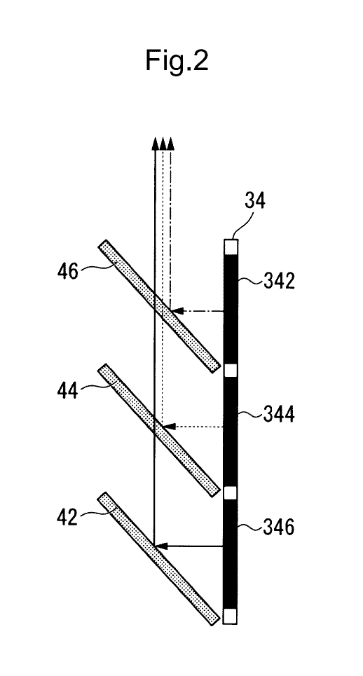

FIG. 1 is a schematic configuration diagram of the display device for a vehicle 1 according to the embodiment. FIG. 2 is a cross-sectional view of a liquid crystal panel 34, mirror 42, second semitransparent mirror 44, and first semitransparent mirror 46 according to the embodiment, and is a diagram for describing reflected light and transmitted light.

As shown in FIG. 1, the display device for a vehicle 1 includes an image output device 10, a design display portion 30, and a virtual image display portion 40. The display device for a vehicle 1 projects an image on a plane of projection 50.

The design display portion 30 includes an image splitting portion 32 and the liquid crystal panel 34. Also, the liquid crystal panel 34 includes a first display area 342, a second display area 344, and a third display area 346 in this order from the side closer to the plane of projection 50. Note that although the embodiment describes an example where a single liquid crystal panel 34 includes three display areas, the liquid crystal panel 34 may be configured of three liquid crystal panels instead.

The virtual image display portion 40 includes the first semitransparent mirror 46, the second semitransparent mirror 44, and the mirror 42 in this order from the side closer to the plane of projection 50. Note that the virtual image display portion 40 may include an unillustrated imaging lens or other parts.

### Operation and Function of Display Device for a Vehicle 1

Next, an operation and function of the display device for a vehicle 1 will be described.

The image output device 10 outputs a display image, which is a single continuous design to be provided to the driver (observer), to the image splitting portion 32. Here, a display image which is a single continuous design is an image such as: a compass image including the traveling direction of the vehicle and a compass; a turn-by-turn image that indicates the traveling direction at an intersection or other points with an arrow icon, for example; an LKAS (Lane Keep Assist System) image; and an ACC (Adaptive Cruise Control) image. Note that LKAS is a system for keeping the vehicle in the lane while driving on the highway or other roads. ACC is a system in which radar installed in the vehicle detects a vehicle running in front of the vehicle, and allows the vehicle to follow the front vehicle by measuring the following distance and speed difference. The display image outputted from the image output device 10 is a two-dimensional image. An image g300 is an example of an image displayed by the display device for a vehicle 1, and is viewed by the driver as an image having depth.

The image splitting portion 32 splits the display image outputted by the image output device 10 into a near view image g102, intermediate view image g104, and distant view image g106, as shown in an image g100. Note that for each of the near view image, intermediate image, and distant image, the image splitting portion 32 converts the area except for the split area into a black image. The image g100 is a display image split by the image splitting portion 32, which is displayed on the liquid crystal panel 34. The near view image g102 is a split design, which is a partial design on the near side in the sight line direction of the driver. Hereinafter in the embodiment, the split design as a partial design on the near side in the sight line direction of the driver is also referred to as a near side split design. The distant view image g106 is a split design, which is a partial design on the far side in the sight line direction of the driver. Hereinafter in the embodiment, the split design as a partial design on the far side in the sight line direction of the driver is also referred to as a far side split design. The intermediate view image g104 is a split design, which is a partial design between the near side split design and the far side split design, in the sight line direction of the driver. Hereinafter in the embodiment, the split design as a partial design between the near side split design and the far side split design is also referred to as an intermediate split design. Note that the image splitting portion 32 also has a drive circuit of the liquid crystal panel 34.

The image splitting portion 32 displays the split near view image g102 in the first display area 342, displays the intermediate view image g104 in the second display area 344, and displays the distant view image g106 in the third display area 346.

The near view image g102 is displayed in the first display area 342 of the liquid crystal panel 34 by the image splitting portion 32.

The intermediate view image g104 is displayed in the second display area 344 by the image splitting portion 32.

The distant view image g106 is displayed in the third display area 346 by the image splitting portion 32.

The mirror 42 is a total reflection mirror. As shown in FIG. 2, the mirror reflects the distant view image g106 displayed in the third display area 346. The distant view image g106 reflected by the mirror 42 penetrates the second semitransparent mirror 44 and the first semitransparent mirror 46, and the transmitted distant view image g106 is projected on the plane of projection 50.

In each of the second semitransparent mirror 44 and the first semitransparent mirror 46, reflectivity and transmissivity is substantially one to one.

As shown in FIG. 2, the second semitransparent mirror 44 reflects the intermediate view image g104 displayed in the second display area 344, and transmits the distant view image g106 reflected by the mirror 42. The intermediate view image g104 reflected by the second semitransparent mirror 44 penetrates the first semitransparent mirror 46, and the transmitted intermediate view image g104 is projected on the plane of projection 50.

As shown in FIG. 2, the first semitransparent mirror 46 reflects the near view image g102 displayed in the first display area 342, transmits the distant view image g106 transmitted by the second semitransparent mirror 44, and transmits the intermediate view image g104 reflected by the second semitransparent mirror 44. The near view image g102 reflected by the first semitransparent mirror 46 is projected on the plane of projection 50.

The plane of projection 50 is a front window (also referred to as windshield) of a vehicle, for example. The near view image g102, intermediate view image g104, and distant view image g106 projected by the display device for a vehicle 1 are projected on the plane of projection 50. A virtual image g200 based on the projected image is formed outside the plane of projection 50, outside the vehicle. A near view virtual image g202 which is a virtual image based on the near view image g102, an intermediate view virtual image g204 which is a virtual image based on the intermediate view image g104, and a distant view virtual image g206 which is a virtual image based on the distant view image g106, are formed in this order from the side closer to the plane of projection 50 in the virtual image g200. Note that the near view virtual image g202 is formed in a position closest to the plane of projection 50. Of the near view virtual image g202, intermediate view virtual image g204, and distant view virtual image g206, the distant view virtual image g206 is formed in a position farthest from the plane of projection 50. The intermediate view virtual image g204 is formed in a position between the near view virtual image g202 and distant view virtual image g206.

The driver views an image, which is a combination of the background outside the vehicle, and the near view virtual image g202, intermediate view virtual image g204, and distant view virtual image g206 formed outside the vehicle.

### Display Image, Split Display Image, Virtual Image, and Image Viewed by the Driver

Next, an example of the display image, split display image, virtual image, and image viewed by the driver will be described.

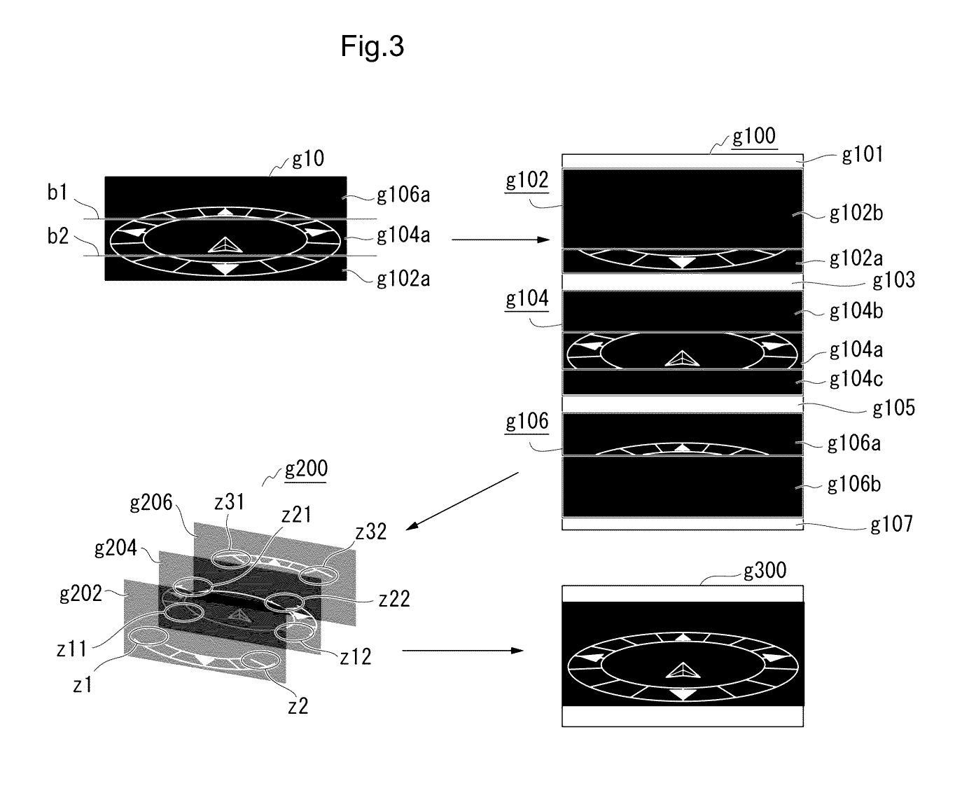

FIG. 3 is a diagram showing an example of a display image, split display image, virtual image, and image viewed by the driver, according to the embodiment. The example shown in FIG. 3 is a compass image.

An image g10 is a display image outputted from the image output device 10. The display image g10 is split into three images which are an image for near view g102a, an image for intermediate view g104a, and an image for distant view g106a by the image splitting portion 32, at preset lines b1 and b2, for example. Note that the image splitting portion 32 may use a known image recognition method to extract an image having a predetermined level or higher brightness included in the display image, and determine the area to be split on the basis of the extracted image.

The image displayed on the liquid crystal panel 34 includes the near view image g102, the intermediate view image g104, and the distant view image g106. The image displayed on the liquid crystal panel 34 further includes: an area where no image is displayed (referred to as no display area below) g101 above the near view image g102; a no display area g103 between the near view image g102 and the intermediate view image g104; a no display area g105 between the intermediate view image g104 and the distant view image g106; and a no display area g107 below the distant view image g106.

The near view image g102 is configured of the image for near view g102a and a black image g102b. The image splitting portion 32 converts the area except for the image for near view g102a into the black image g102b.

The intermediate view image g104 is configured of the image for intermediate view g104a, a black image g104b, and a black image g104c. The image splitting portion 32 converts the area except for the image for intermediate view g104a into the black image g104b and black image g104c.

The distant view image g106 is configured of the image for distant view g106a and a black image g106b. The image splitting portion 32 converts the area except for the image for distant view g106a into the black image g106b.

As shown in the virtual image g200 in FIG. 3, the images are displayed in the respective display areas of the liquid crystal panel 34, in such a manner that the near view image g102 continues into the intermediate view image g104 from the near side, and the intermediate view image g104 continues into the distant view image g106 from the near side.

Note that the image splitting portion 32 may detect the brightness of each of the split image for near view g102a, image for intermediate view g104a, and image for distant view g106a. Then, if each detected brightness is within a predetermined range, the image splitting portion 32 may set the brightness of the image for near view g102a, among the split display images, higher than that of the image for intermediate view g104a, and set the brightness of the image for distant view g106a lower than that of the image for intermediate view g104a. Thus, the embodiment can set different brightnesses for the image for near view g102a, image for intermediate view g104a, and image for distant view g106a, to thereby allow the driver to sense the depth even more when he/she views the display image.

The virtual image g200 includes the near view virtual image g202 of the near view image g102, the intermediate view virtual image g204 of the intermediate view image g104, and the distant view virtual image g206 of the distant view image g106.

Since the near view virtual image g202 and the intermediate view virtual image g204 are superimposed on one another, an image is formed where an area of the near view virtual image g202 surrounded by a circle z1 is continuous with an area of the intermediate view virtual image g204 surrounded by a circle z11, and an area of the near view virtual image g202 surrounded by a circle z2 is continuous with an area of the intermediate view virtual image g204 surrounded by a circle z12.

Since the intermediate view virtual image g204 and the distant view virtual image g206 are superimposed on one another, an image is formed where an area of the intermediate view virtual image g204 surrounded by a circle z21 is continuous with an area of the distant view virtual image g206 surrounded by a circle z31, and an area of the intermediate view virtual image g204 surrounded by a circle z22 is continuous with an area of the distant view virtual image g206 surrounded by a circle z32.

The near view virtual image g202, intermediate view virtual image g204, and distant view virtual image g206 are superimposed on one another, and the driver views an image shown as the image g300.

Next, an example of a turn-by-turn image will be described.

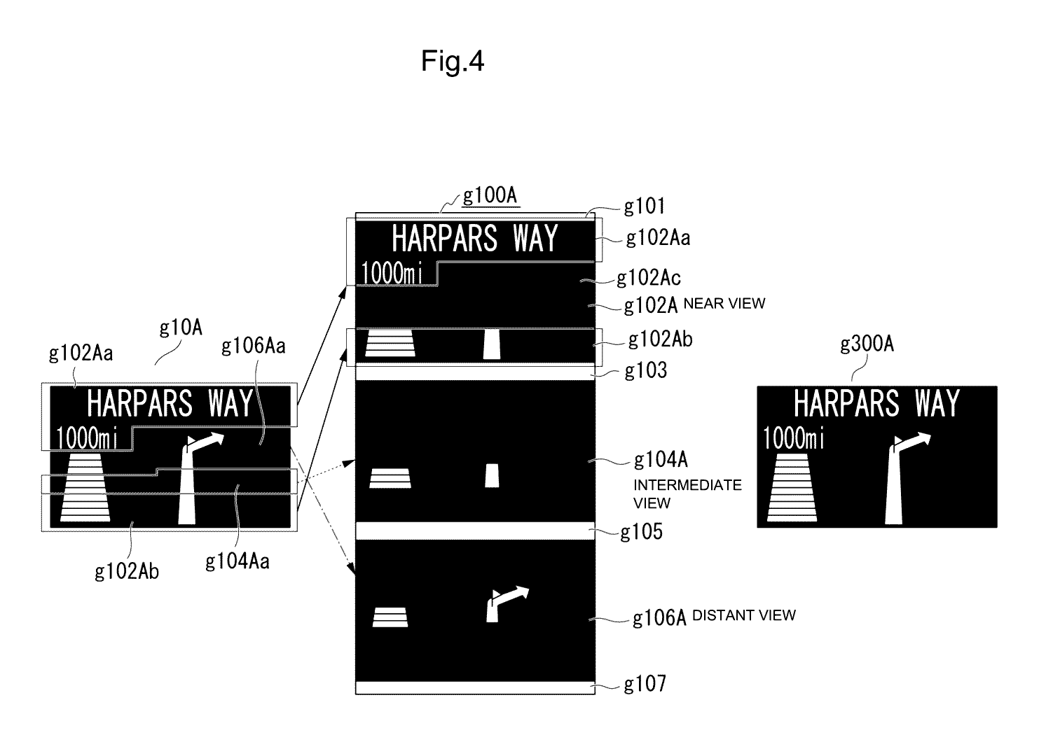

FIG. 4 is a diagram showing another example of the display image, split display image, virtual image, and image viewed by the driver according to the embodiment. The example shown in FIG. 4 is a turn-by-turn image.

An image g10A is a display image outputted from the image output device 10. The display image g10A is split into images for near view g102Aa and g102Ab, an image for intermediate view g104Aa, and an image for distant view g106Aa by the image splitting portion 32.

For example, a near view image g102A is configured of the images for near view g102Aa and g102Ab, and a black image g102Ac. The image splitting portion 32 converts the area except for the images for near view g102Aa and g102Ab into the black image g102Ac.

An image g100A displayed on the liquid crystal panel 34 includes the no display area g101, the near view image g102A, the no display area g103, an intermediate view image g104A, the no display area g105, a distant view image g106A, and a no display area g107.

In the example shown in FIG. 4, too, the images are displayed in the respective display areas of the liquid crystal panel 34, in such a manner that the near view image g102A continues into the intermediate view image g104A from the near side, and the intermediate view image g104A continues into the distant view image g106A from the near side.

A near view virtual image g202A, intermediate view virtual image g204A, and distant view virtual image g206A are superimposed on one another, and the driver views an image indicated as an image g300A.

### Processing of Display Device for a Vehicle 1

Next, an example of a processing procedure carried out by the display device for a vehicle 1 will be described.

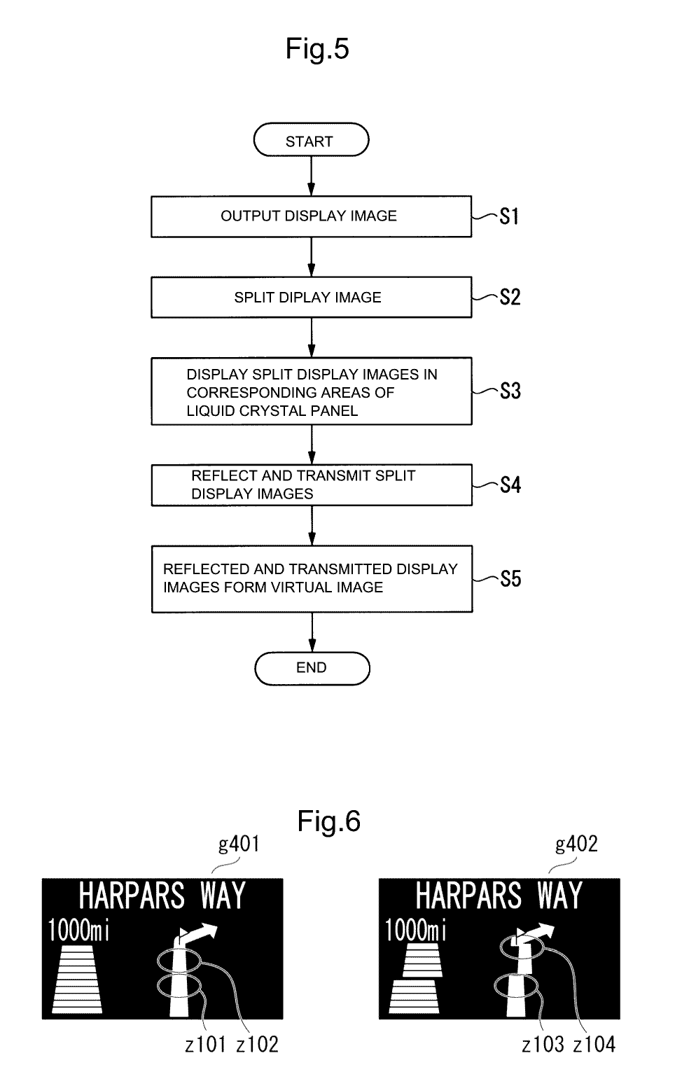

FIG. 5 is a flowchart of processing performed by the display device for a vehicle 1 according to the embodiment.

(Step S1) The image output device 10 outputs a display image, which is a single continuous design to be provided to the driver, to the image splitting portion 32.

(Step S2) The image splitting portion 32 splits the display image outputted by the image output device 10 into an image for near view, image for intermediate view, and image for distant view. Then, the image splitting portion 32 generates a near view image by converting the area except for the image for near view into a black image. Then, the image splitting portion 32 generates an intermediate view image by converting the area except for the image for intermediate view into a black image. Then, the image splitting portion 32 generates a distant view image by converting the area except for the image for distant view into a black image. Note that the step of splitting the display image includes the step of generating the near view image, intermediate view image, and distant view image.

(Step S3) The image splitting portion 32 displays the split near view image in the first display area 342, the intermediate view image in the second display area 344, and the distant view image in the third display area 346.

Specifically the image splitting portion 32 displays, among the multiple split designs (near view image, intermediate view image, and distant view image), the near side split design (near view image) which is the split design on the near side in the sight line direction of the driver, in such a manner that it continues into the intermediate split design (intermediate view image) which is the split design on the far side of the sight line direction of the driver, from the near side. Moreover, the image splitting portion 32 displays the intermediate split design (intermediate view image) in such a manner that it continues into the far side split design (distant view image), among the multiple split designs, from the near side. This allows the near view image, the intermediate view image, and the distant view image to appear continuous from the near side when viewed by the driver.

(Step S4) The mirror 42 reflects the distant view image displayed in the third display area 346. The distant view image reflected by the mirror 42 penetrates the second semitransparent mirror 44 and the first semitransparent mirror 46, and the transmitted distant view image is projected on the plane of projection 50. Then, the second semitransparent mirror 44 reflects the intermediate view image displayed in the second display area 344, and transmits the distant view image reflected by the mirror 42. Thereafter, the intermediate view image reflected by the second semitransparent mirror 44 penetrates the first semitransparent mirror 46, and the transmitted intermediate view image is projected on the plane of projection 50. Then, the first semitransparent mirror 46 reflects the near view image displayed in the first display area 342, transmits the distant view image transmitted by the second semitransparent mirror 44, and transmits the intermediate view image reflected by the second semitransparent mirror 44. The near view image reflected by the first semitransparent mirror 46 is projected on the plane of projection 50.

(Step S5) The near view image, intermediate view image, and distant view image projected by the display device for a vehicle 1 are projected on the plane of projection 50. As a result, the virtual image g200 (near view virtual image g202, intermediate view virtual image g204, and distant view virtual image g206) based on the projected images is formed outside the plane of projection 50, outside the vehicle.

The driver views an image in which the near view virtual image g202, intermediate view virtual image g204, and distant view virtual image g206 formed in the above manner are superimposed on one another.

Note that although the above example has been described by using a case where a single continuous display image is split into three, the image may be split into two, four, or more instead. When splitting the image into two, a combination of the near view image and intermediate view image, or the intermediate view image and distant view image may be used, for example. If there are two display images, the liquid crystal panel 34 may include at least two display areas, and if there are four or more display images, the liquid crystal panel may include display areas of a number corresponding to the number of display images.

Also, the image output device 10 may associate, with image information, information indicating whether it is for near view, intermediate view, or distant view, for every predetermined pixel block (e.g. 10×10 pixels), for example, and output it to the image splitting portion 32. The image splitting portion 32 may split an image into an image for near view, image for intermediate view, and image for distant view, according to the information associated with the image information outputted from the image output device 10, which indicates whether it is for near view, intermediate view, or distant view. Note that the image output device 10 may include the function of the image splitting portion 32, split a display image, which is a single continuous design, into a near view image, intermediate view image, and distant view image, and output the split near view image, intermediate view image, and distant view image to the liquid crystal panel 34.

As has been described, the display device for a vehicle of the embodiment includes: a design display part [image output device 10 and design display portion 30 (image splitting portion 32 and liquid crystal panel 34)] for generating multiple split designs (e.g. near view image g102, intermediate view image g104, and distant view image g106) into which a single continuous design (e.g. display image g10) is split; and multiple virtual image display parts [virtual image display portion 40 (mirror 42, second semitransparent mirror 44, and first semitransparent mirror 46)] for respectively displaying virtual images of corresponding split designs. Each virtual image display part displays, among the multiple split designs, a near side split design (e.g. near view image g102) which is the split design on the near side in the sight line direction of the driver, in such a manner that it continues into a far side split design (e.g. distant view image g106) which is the split design on the far side in the sight line direction of the driver, from the near side.

According to the embodiment configured in this manner, the display image which is a single continuous design is split into the near view image, intermediate view image, and distant view image, and the split images appear continuous from the near side. Hence, an image having depth can be displayed, so that the observer can sense the depth.

Also, in the display device for a vehicle of the embodiment, the multiple split designs include n (n is two or a larger integer) split designs (e.g. n=3); the design display portion 30 (image splitting portion 32 and liquid crystal panel 34) includes a liquid crystal display (liquid crystal panel 34) having n display areas (first display area 342, second display area 344, and third display area 346); the near side split design (e.g. near view image) is displayed in a first display area (e.g. first display area 342) of the n display areas; and the far side split design (e.g. distant view image) is displayed in an n-th display area (e.g. third display area 346) of the n display areas.

Also, in the display device for a vehicle of the embodiment, the multiple virtual image display parts [virtual image display portion 40 (mirror 42, second semitransparent mirror 44, and first semitransparent mirror 46)] include the single mirror 42 and (n−1) semitransparent mirrors (e.g. second semitransparent mirror 44 and first semitransparent mirror 46); the mirror reflects the far side split design (distant view image) displayed in the n-th display area (e.g. third display area 346); and the first semitransparent mirror 46, which is closest to a plane of projection on which the multiple split designs are projected among the (n−1) semitransparent mirrors, transmits the far side split design reflected by the mirror, and reflects the near side split design (near view image) displayed in the first display area 342, to project the images on the plane of projection 50.

According to the embodiment configured in this manner, the split near view image is displayed in the first display area 342 of the liquid crystal panel 34, and the distant view image is displayed in the third display area 346. Hence, an image having depth can be displayed, so that the observer can sense the depth.

Also, in the display device for a vehicle of the embodiment, the multiple split designs include three split designs (near view image, intermediate view image, and distant view image); the design display portion 30 (image splitting portion 32 and liquid crystal panel 34) includes a liquid crystal display (liquid crystal panel 34) having three display areas (first display area 342, second display area 344, and third display area 346); the near side split design (e.g. near view image g102) is displayed in the first display area 342 of the three display areas; the far side split design (e.g. distant view image g106) is displayed in the third display area 346 of the three display areas; an intermediate split design (e.g. intermediate view image g104), which is the split design between the near side split design and the far side split design, is displayed in the second display area 344 of the three display areas; the multiple virtual image display parts [virtual image display portion 40 (mirror 42, second semitransparent mirror 44, and first semitransparent mirror 46)] include the single mirror 42, the first semitransparent mirror 46, and the second semitransparent mirror 44; the first semitransparent mirror, the second semitransparent mirror, and the mirror are arranged in this order from the side closer to the plane of projection 50 on which the multiple split designs are projected; the mirror reflects the far side split design displayed in the third display area; the second semitransparent mirror transmits the far side split design reflected by the mirror, and reflects the intermediate split design displayed in the second display area; and the first semitransparent mirror transmits the far side split design transmitted by the second semitransparent mirror and the intermediate split design reflected by the second semitransparent mirror, and reflects the near side split design displayed in the third display area, to project the images on the plane of projection.

According to the embodiment configured in this manner, the split near view image is displayed in the first display area 342 of the liquid crystal panel 34, and the near view image displayed in the first display area 342 is projected on the plane of projection 50 by the first semitransparent mirror 46, to be displayed as the near view virtual image g202. Also, the intermediate view image is displayed in the second display area 344, and the intermediate view image displayed in the second display area 344 is reflected by the second semitransparent mirror 44, the reflected intermediate view image penetrates the first semitransparent mirror 46 and is projected on the plane of projection 50, to be displayed as the intermediate view virtual image g204. Furthermore, the distant view image is displayed in the third display area 346, and the distant view image displayed in the third display area 346 is reflected by the mirror 42, the reflected distant view image penetrates the second semitransparent mirror 44 and the first semitransparent mirror 46 and is projected on the plane of projection 50, to be displayed as the distant view virtual image g206. As a result, the embodiment allows an image having depth to be displayed, so that the observer can sense the depth.

### Second Embodiment

The first embodiment described an example where a single continuous display image is split into three, which are the near view image, intermediate view image, and distant view image, and the split near view image, intermediate view image, and distant view image are respectively displayed in different display areas of the liquid crystal panel 34.

This embodiment describes a display device for a vehicle 1A, which makes it less likely for a continuous image such as a vertical line to appear shifted in the horizontal direction, when the driver views multiple superimposed display images.

FIG. 6 is a diagram showing an example of how a continuous image such as a vertical line appears shifted in the horizontal direction, when the driver views multiple superimposed display images.

An image g401 is a turn-by-turn image. In the example of the image g401, lines and images in areas surrounded by circles z101 and z102 are continuous. Assume that this image g401 is split into three, and the driver views three virtual images projected by a liquid crystal panel 34, a mirror 42, a second semitransparent mirror 44, and a first semitransparent mirror 46. In this case, the lines and images may appear shifted in the horizontal direction as in areas surrounded by circles z103 and z104 in an image g402, due to insufficient accuracy in part attachment or secular change, for example.

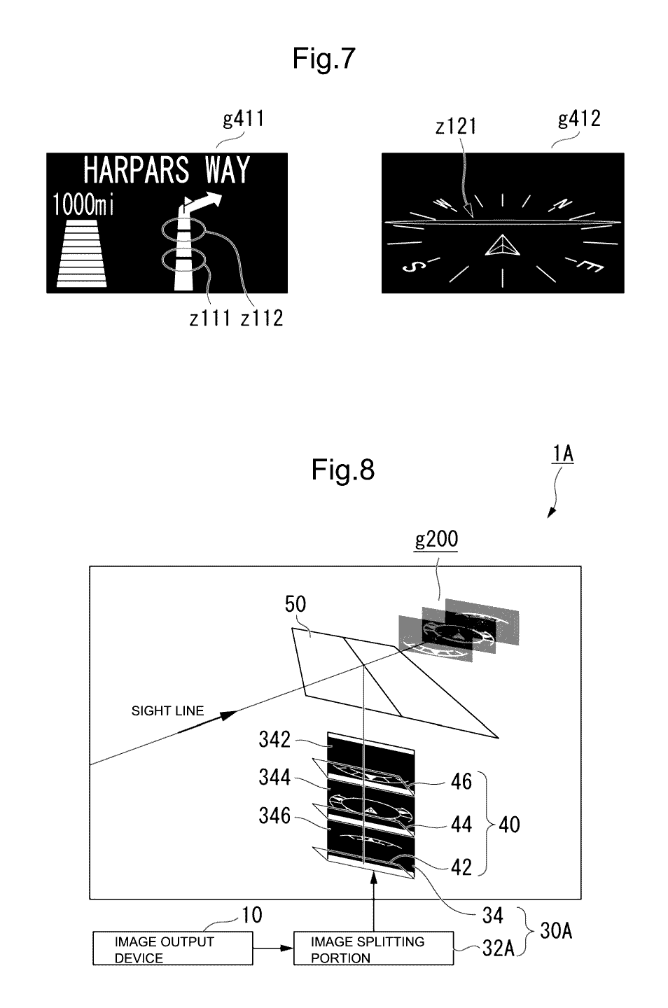

FIG. 7 is a diagram showing examples of an image viewed by the driver, based on a display image having lines and images that are discontinuous in split areas, according to the embodiment.

An image g411 is a turn-by-turn image. In the example of the image g411, lines and images in areas surrounded by circles z111 and z112 are discontinuous. Note that in the embodiment, such a single display image having a discontinuous line or image is still a single continuous design, since it is a single turn-by-turn image.

An image g412 is a compass image. In the example of the image g412, images and lines in an area surrounded by a circle z121 are discontinuous, for example.

### Configuration of Display Device for a Vehicle 1A

Next, a configuration of the display device for a vehicle 1A will be described.

FIG. 8 is a schematic configuration diagram of the display device for a vehicle 1A according to the embodiment. As shown in FIG. 8, the display device for a vehicle 1A includes an image output device 10, a design display portion 30A, and a virtual image display portion 40. The design display portion 30A includes an image splitting portion 32A and the liquid crystal panel 34. Note that components having the same function as those in the display device for a vehicle 1 are assigned the same reference numerals, and descriptions thereof will be omitted.

The image splitting portion 32A splits a display image outputted by the image output device 10 into a near view image, intermediate view image, and distant view image. The image splitting portion 32A deletes parts of lines and images that are continuous between the split near view image and intermediate view image, and makes them discontinuous between the split areas. Also, the image splitting portion 32A deletes parts of lines and images that are continuous between the split intermediate view image and distant view image, and makes them discontinuous between the split areas. In addition, the image splitting portion 32A converts an area except for the split areas into a black image, in each of the near view image, intermediate view image, and distant view image. Note that the image splitting portion 32A also has a drive circuit of the liquid crystal panel 34. The image splitting portion 32A displays the split near view image in a first display area 342, the intermediate view image in a second display area 344, and the distant view image in a third display area 346.

Note that in a case where the image output device 10 associates, for predetermined pixels, information indicating whether it is for near view image, intermediate view image, or distant view image, when outputting them to the image splitting portion 32A, the image output device 10 may output a display image having discontinuous lines and images in split areas.

### Display Image, Image Displayed on a Liquid Crystal Panel, Virtual Image, and Viewed Image

Next, an example of a display image, image displayed on a liquid crystal panel, virtual image, and viewed image will be described.

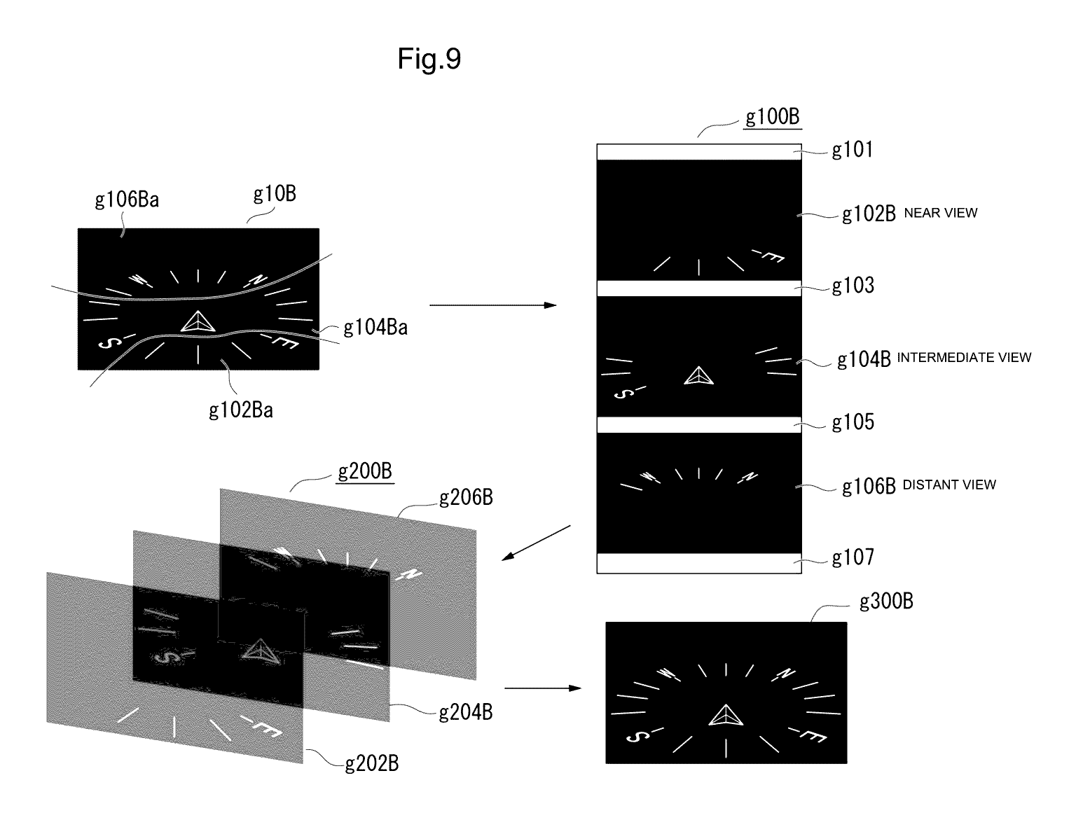

FIG. 9 is a diagram showing an example of a display image, image displayed on a liquid crystal panel, virtual image, and image viewed by the driver, according to the embodiment. The example shown in FIG. 9 is a compass image.

An image g10B is a display image outputted from the image output device 10. The display image g10B is split into an image for near view g102Ba, an image for intermediate view g104Ba, and an image for distant view g106Ba by the image splitting portion 32A.

A near view image g102B is configured of the image for near view g102Ba, and a black image, which is the area except for the image for near view g102Ba.

An intermediate view image g104B is configured of the image for intermediate view g104Ba, and a black image, which is the area except for the image for intermediate view g104Ba.

A distant view image g106B is configured of the image for distant view g106Ba, and a black image, which is the area except for the image for distant view g106Ba.

The image displayed on the liquid crystal panel 34 includes a no display area g101, the near view image g102B, a no display area g103, the intermediate view image g104B, a no display area g105, the distant view image g106B, and a no display area g107.

In the example shown in FIG. 9, too, the images are displayed in the respective display areas of the liquid crystal panel 34, in such a manner that the near view image g102B continues into the intermediate view image g104B from the near side, and the intermediate view image g104B continues into the distant view image g106B from the near side.

Also, in a virtual image g200B, a near view virtual image g202B is formed on the basis of the near view image g102B, an intermediate view virtual image g204B is formed on the basis of the intermediate view image g104B, and a distant view virtual image g206B is formed on the basis of the distant view image g106B, in this order from the side closer to a plane of projection 50.

The near view virtual image g202B, intermediate view virtual image g204B, and distant view virtual image g206B are superimposed on one another, and the driver views an image shown as an image g300B.

Next, another display image example will be described.

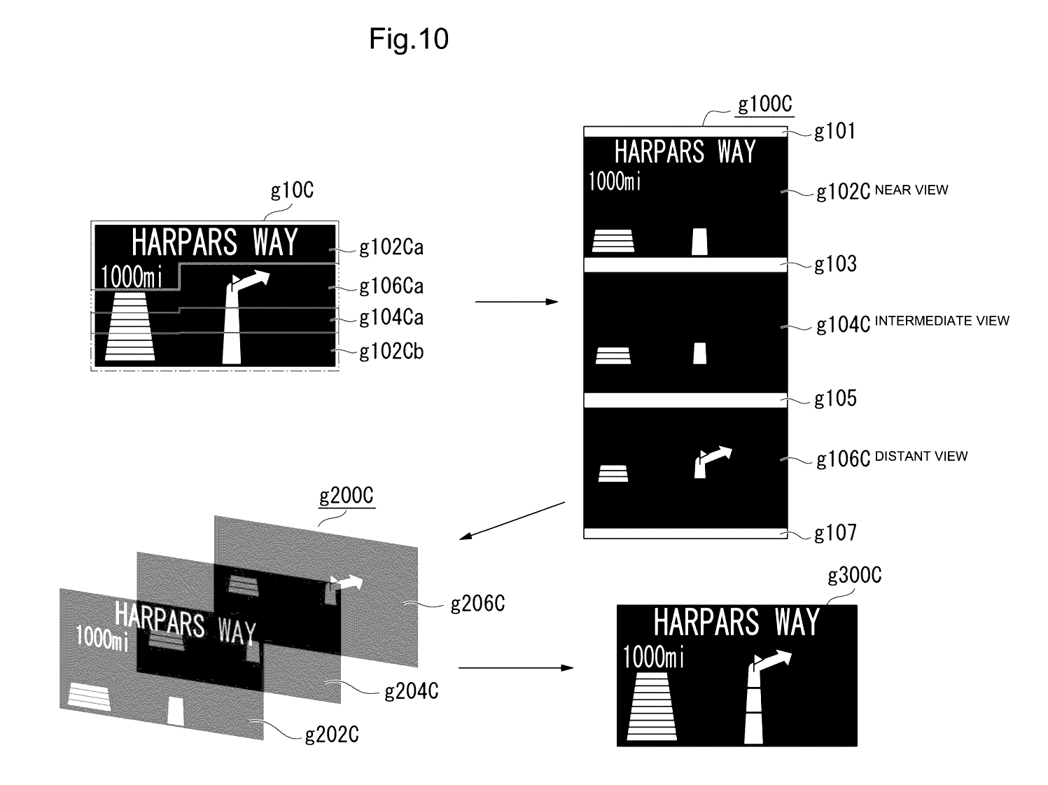

FIG. 10 is a diagram showing another example of the display image, image displayed on a liquid crystal panel, virtual image, and image viewed by the driver, according to the embodiment. The example shown in FIG. 10 is a turn-by-turn image.

An image g10C is a display image outputted from the image output device 10. The display image g10C is split into images for near view g102Ca and g102Cb, an image for intermediate view g104Ca, and an image for distant view g106Ca by the image splitting portion 32A.

A near view image g102C is configured of the images for near view g102Ca and g102Cb, and a black image, which is the area except for the images for near view g102Ca and g102Cb.

An intermediate view image g104C is configured of the image for intermediate view g104Ca, and a black image, which is the area except for the image for intermediate view g104Ca.

A distant view image g106C is configured of the image for distant view g106Ca, and a black image, which is the area except for the image for distant view g106Ca.

The image displayed on the liquid crystal panel 34 includes the no display area g101, the near view image g102C, the no display area g103, the intermediate view image g104C, the no display area g105, the distant view image g106C, and the no display area g107.

In the example shown in FIG. 10, too, the images are displayed in the respective display areas of the liquid crystal panel 34, in such a manner that the near view image g102C continues into the intermediate view image g104C from the near side, and the intermediate view image g104C continues into the distant view image g106C from the near side.

Also, in a virtual image g200C, a near view virtual image g202C is formed on the basis of the near view image g102C, an intermediate view virtual image g204C is formed on the basis of the intermediate view image g104C, and a distant view virtual image g206C is formed on the basis of the distant view image g106C, in this order from the side closer to the plane of projection 50.

The near view virtual image g202C, intermediate view virtual image g204C, and distant view virtual image g206C are superimposed on one another, and the driver views an image shown as an image g300C.

As in the examples shown in FIGS. 9 and 10, the multiple split designs (image for near view, image for intermediate view, and image for distant view) of the embodiment do not have lines continuous between adjacent split designs. As a result, since adjacent split designs do not have lines continuous therebetween, the embodiment makes it less likely for a continuous image such as a vertical line to appear shifted in the horizontal direction, even when accuracy in part attachment is insufficient, or when there has been a secular change, for example.

### Processing of Display Device for a Vehicle 1A

Next, an example of a processing procedure carried out by the display device for a vehicle 1A will be described.

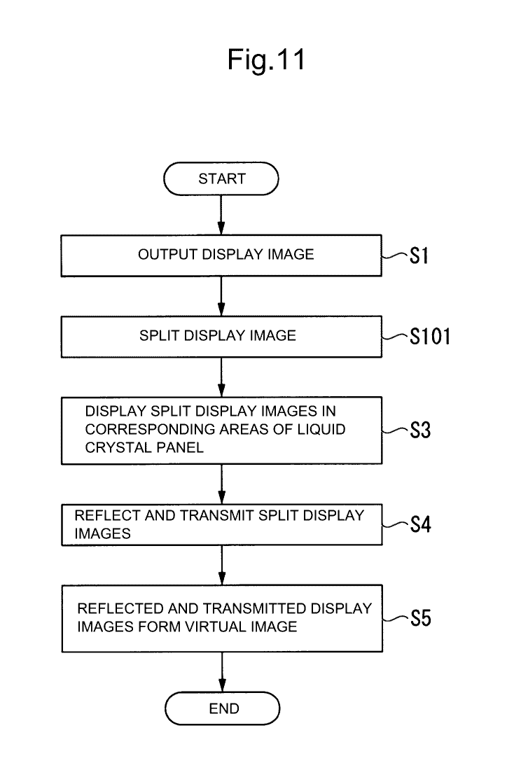

FIG. 11 is a flowchart of processing performed by the display device for a vehicle 1A according to the embodiment. Note that the same processing as that performed by the display device for a vehicle 1 is assigned the same reference numeral, and descriptions thereof will be omitted. The image splitting portion 32A performs the processing of step S101, instead of the processing of step S2 in the flowchart shown in FIG. 6.

(Step S101) The image splitting portion 32A splits the display image outputted by the image output device 10 into an image for near view, image for intermediate view, and image for distant view. Then, the image splitting portion 32A deletes parts of lines and images that are continuous between the split near view image and intermediate view image, and makes them discontinuous between the split areas. Then, the image splitting portion 32A deletes parts of lines and images that are continuous between the split intermediate view image and distant view image, and makes them discontinuous between the split areas. Then, the image splitting portion 32A converts the area except for the image for near view into a black image, to generate a near view image. Then, the image splitting portion 32A converts the area except for the image for intermediate view into a black image, to generate an intermediate view image. Thereafter, the image splitting portion 32A converts the area except for the image for distant view into a black image, to generate a distant view image. Note that in this embodiment, too, the step of splitting the display image includes the step of generating the near view image, intermediate view image, and distant view image.

### When each of Display Image, Image Displayed on a Liquid Crystal Panel, Virtual Image, and Viewed Image Varies Over Time

Next, an example will be described where each of a display image, image displayed on a liquid crystal panel, virtual image, and viewed image varies over time.

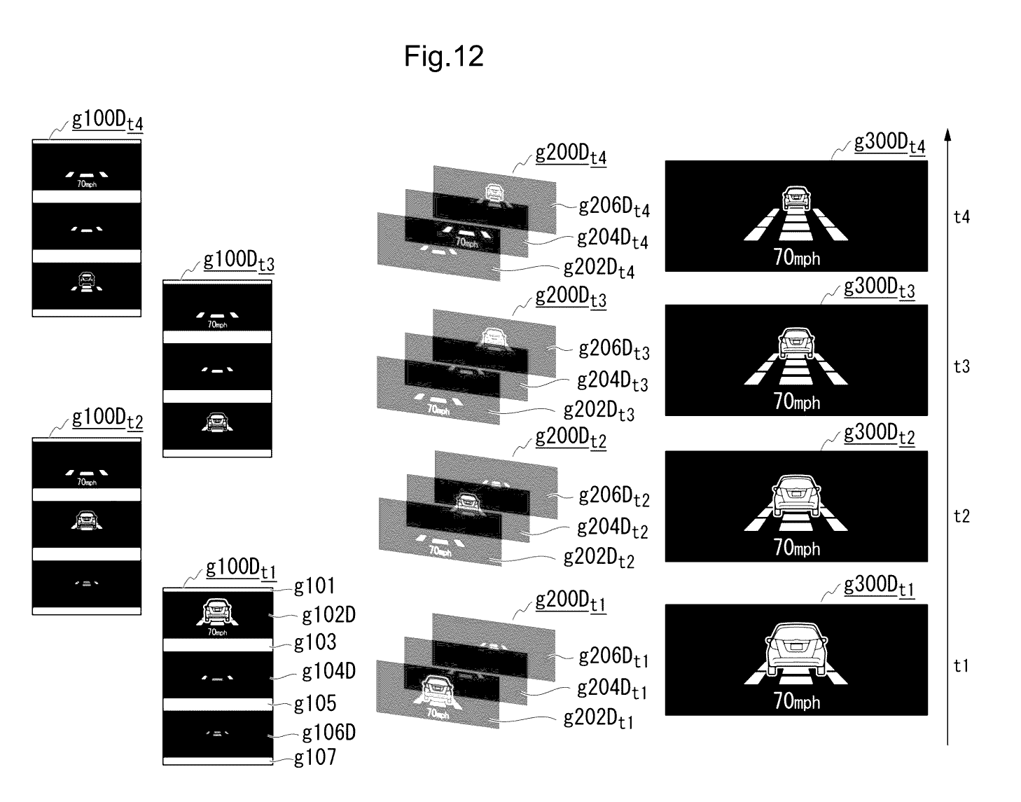

FIG. 12 is a diagram showing an example of how each of an image displayed on a liquid crystal panel, virtual image, and image viewed by the driver according to the embodiment varies over time. Note that FIG. 12 is an example of an LKAS image and an ACC image.

Also, display images at the respective times are omitted in FIG. 12. The display images at the respective times are two-dimensional images of viewed images g300Dₜ₁ to g300Dₜ₄.

Each of images displayed on the liquid crystal panel 34 at times t1 to t4 includes the no display area g101, a near view image g102D, the no display area g103, an intermediate view image g104D, the no display area g105, a distant view image g106D, and the no display area g107.

In the example shown in FIG. 12, too, the images are displayed in the respective display areas of the liquid crystal panel 34, in such a manner that the near view image g102D continues into the intermediate view image g104D from the near side, and the intermediate view image g104D continues into the distant view image g106D from the near side.

At time t1, each of the near view image g102D, intermediate view image g104D, and distant view image g106D split by the image splitting portion 32A is displayed in a corresponding area of the liquid crystal panel 34, as in an image g100Dₜ₁. The image g100Dₜ₁ projected by the mirror 42, second semitransparent mirror 44, and first semitransparent mirror 46 forms the virtual image g200Dₜ₁. Note that a near view virtual image g202Dₜ₁ is a virtual image based on a near view image g102Dₜ₁, an intermediate view virtual image g204Dₜ₁ is a virtual image based on an intermediate view image g104Dₜ₁, and a distant view virtual image g206Dₜ₁ is a virtual image based on a distant view image g106Dₜ₁. The near view virtual image g202Dₜ₁, intermediate view virtual image g204Dₜ₁, and distant view virtual image g206Dₜ₁ are superimposed on one another, and the driver views an image g300Dₜ₁.

Thereafter, at time t(n) (n is an integer of two to four) each of the near view image g102D, intermediate view image g104D, and distant view image g106D split by the image splitting portion 32A is displayed in a corresponding area of the liquid crystal panel 34, as in an image g100Dₜ₍ₙ₎. The image g100Dₜ₍ₙ₎ projected by the mirror 42, second semitransparent mirror 44, and first semitransparent mirror 46 forms a virtual image g200Dₜ₍ₙ₎. A near view virtual image g202Dₜ₍ₙ₎, intermediate view virtual image g204Dₜ₍ₙ₎, and distant view virtual image g206Dₜ₍ₙ₎ are superimposed on one another, and the driver views an image g300Dₜ₍ₙ₎.

As has been described, in the display device for a vehicle of the embodiment, the multiple split designs do not have lines continuous between adjacent split designs.

According to the embodiment configured in this manner, since adjacent split designs do not have lines continuous therebetween, a continuous image such as a vertical line is less likely to appear shifted in the horizontal direction, even when accuracy in part attachment is insufficient, or when there has been a secular change, for example.

### Third Embodiment

The first and second embodiments described examples in which a display image outputted by the image output device 10 is split into a near view image, intermediate view image, and distant view image by the image splitting portion 32 or 32A.

This embodiment describes an example where an image splitting portion selects a display image, according to contents of an instruction given by the driver.

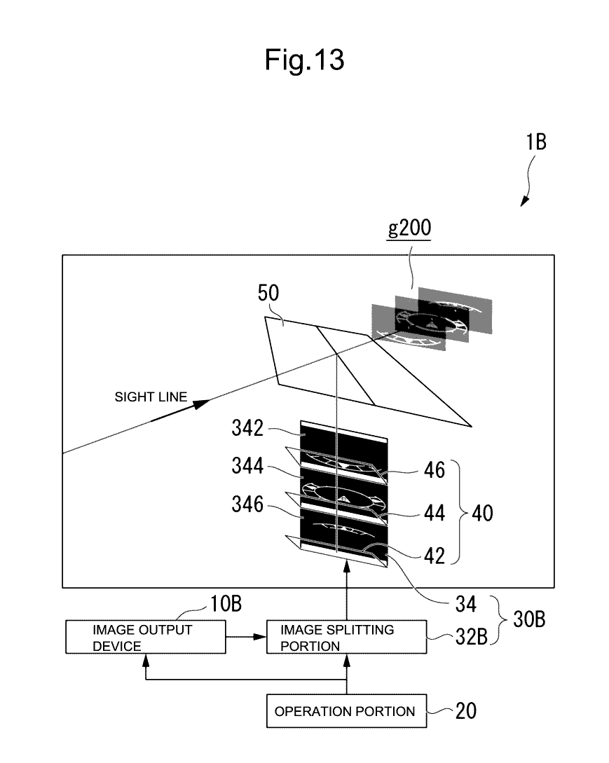

FIG. 13 is a schematic configuration diagram of a display device for a vehicle 1B according to the embodiment. As shown in FIG. 13, the display device for a vehicle 1B includes an image output device 10B, an operation portion 20, a design display portion 30B, and a virtual image display portion 40. The design display portion 30B includes an image splitting portion 32B and a liquid crystal panel 34. Note that components having the same function as those in the display device for a vehicle 1 are assigned the same reference numerals, and descriptions thereof will be omitted.

The image output device 10B outputs information on a display image, which is a single continuous design to be provided to the driver, to the image splitting portion 32B. Here, information on a display image is information on a symbol, information on the size of a character, information on the color of a character, information on the displayed boldness of a character, information on the display position of a character, information on a box image, and information on a tab, for example. Note that details of the pieces of information will be described later. Also, the image output device 10B switches display images, according to an input result outputted by the operation portion 20. Note that the switched display images are an image of a “Speed Dial” display in which a name and telephone number are displayed, an image of a “Call History” display in which a history of originated or received calls is displayed, for example, in a display image of a telephone book.

The operation portion 20 is a joystick, a touch panel, or an arrow key, for example. The operation portion 20 is operated by the driver or an occupant sitting in the passenger's seat, and outputs the received input result to the image output device 10B and the image splitting portion 32B.

The image splitting portion 32B splits the display image outputted by the image output device 10B into a near view image, intermediate view image, and distant view image according to the input result outputted by the operation portion 20. Also, the image splitting portion 32B changes the size or displayed boldness of a character, according to the input result outputted by the operation portion 20. Note that the image splitting portion 32B also has a drive circuit of the liquid crystal panel 34. The image splitting portion 32B displays the split near view image in a first display area 342, displays the intermediate view image in a second display area 344, and displays the distant view image in a third display area 346. Note that in this embodiment, too, if there are lines and images continuous between two adjacent split images, the image splitting portion 32B may delete the lines and images continuous between the images as in the second embodiment.

### Example of Display Image and Image Viewed by the Driver

Next, an example of a display image and image viewed by the driver will be described, by use of image data of a telephone book.

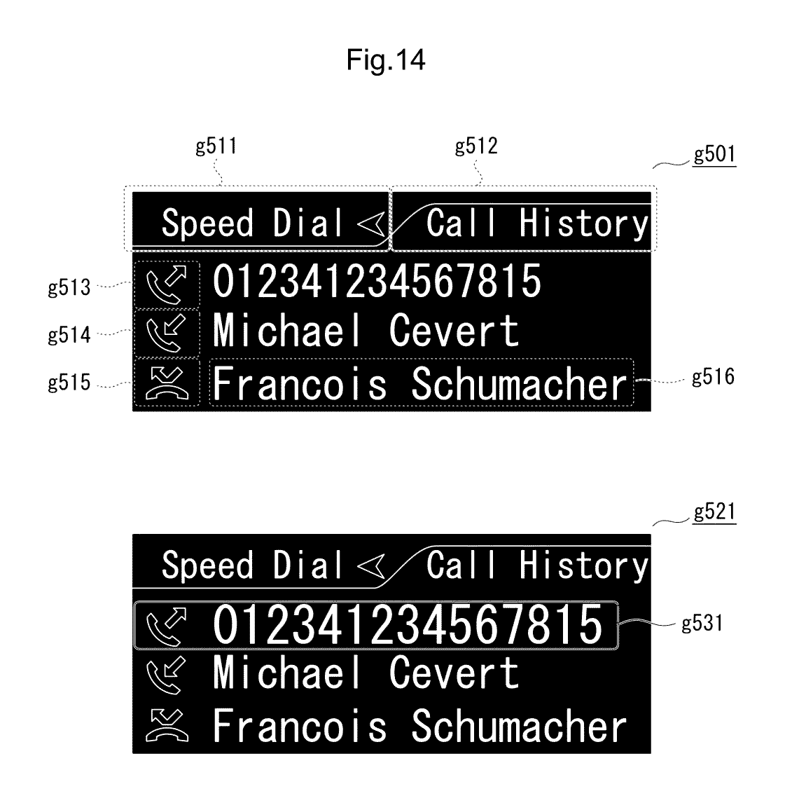

FIG. 14 is an example of a display image of a telephone book and image viewed by the driver, according to the embodiment. In FIG. 14, an image g501 is an example of the display image of a telephone book outputted from the image output device 10B, and an image g521 is an example of the image viewed by the driver.

In the image g501, areas indicated by reference numerals g511 and g512 are examples of tab images. When the driver operates the operation portion 20, the display is switched between the “Speed Dial” tab and “Call History” tab. The image g501 is an example of the “Call History” display when the “Call History” tab is selected. Areas indicated by reference numerals g513 to g515 are examples of symbol images. Reference numeral g513 indicates an originated call, reference numeral g514 indicates a received call, and reference numeral g515 indicates a callback (sometimes referred to simply as a return call, for example, below). An area indicated by reference numeral g516 is a character image. Characters indicate a name or a telephone number, for example.

Also, information on a symbol is information on the display position of a symbol, type of symbol, display color of a symbol, and image size of a symbol, for example.

Additionally, information on the size of a character is information related to the size of a character, information on the color of a character is information related to the display color of a character, information on the displayed boldness of a character is information related to the displayed boldness of a character, and information on the display position of a character is information related to the display position of a character.

In the image g521, an area indicated by reference numeral g531 is an example of a box image, which the operation portion 20 uses to indicate a part (including at least one of a symbol and characters) selected by the driver's operation.

Information on a box image is information related to the display position of a box image, and information related to the display color of a box image, for example.

Next, an example of splitting a display image according to a part selected by the driver will be described.

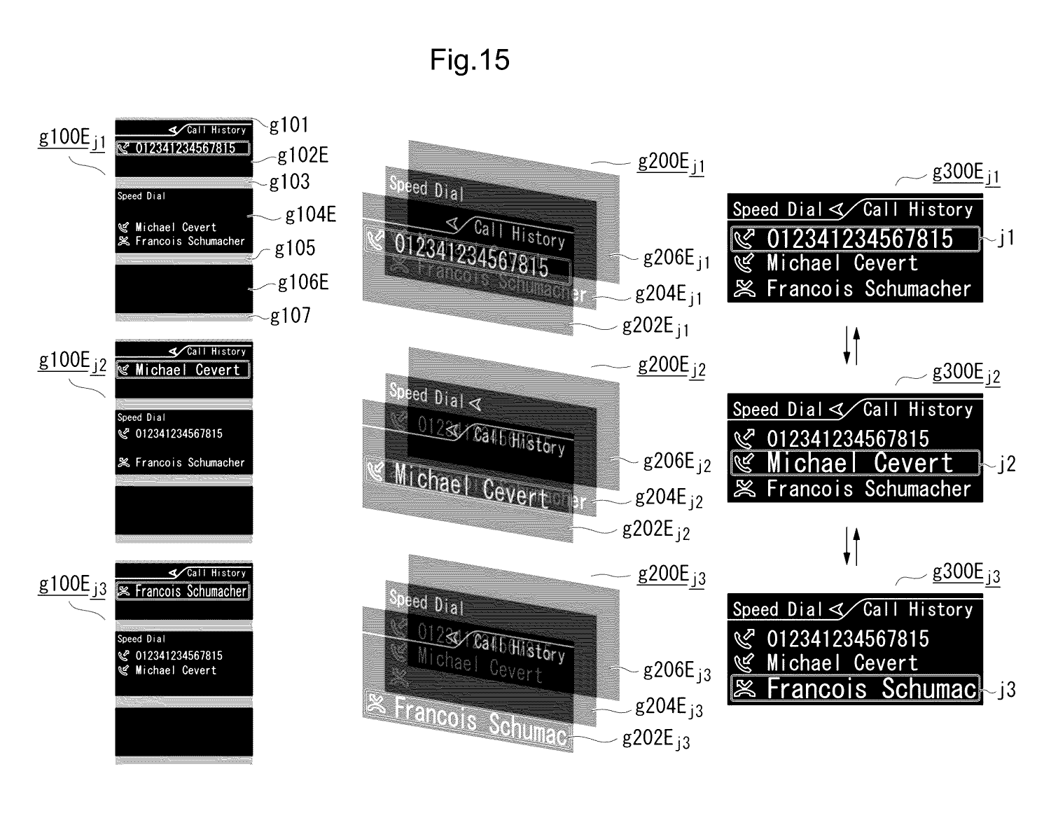

FIG. 15 is a diagram showing an example of how a display image is split according to a part selected by the driver, according to the embodiment. In FIG. 15, a state where a called telephone number “012341234567815” is selected is referred to as a state j1, a state where a name of a person “Michael Cevert” from which a call has been received is selected is referred to as a state j2, and a state where a name of a person “Francois Schumacher” to which a return call has been made is selected is referred to as a state j3.

In the state j1, the image splitting portion 32B splits the display image into three as in an image g100Eⱼ₁, and selects the selected image of the called telephone number (including symbol image) as an image for near view. Then, the image splitting portion 32B makes the size of the characters in the selected part larger than the characters of the display image. Then, the image splitting portion 32B displays the split images in corresponding areas of the liquid crystal panel 34. Note that a box image is added to the near view image by the image splitting portion 32B.

In the state j2, the image splitting portion 32B splits the display image into three as in an image g100Eⱼ₂, and selects the selected image of the name of the person from which a call has been received (including symbol image) as an image for near view. Then, the image splitting portion 32B makes the size of the characters in the selected part larger than the characters of the display image. Then, the image splitting portion 32B displays the split images in corresponding areas of the liquid crystal panel 34.

In the state j3, the image splitting portion 32B splits the display image into three as in an image g100Eⱼ₃, and selects the selected image of the name of the person to which a return call has been made (including symbol image) as an image for near view. Then, the image splitting portion 32B makes the size of the characters in the selected part larger than the characters of the display image. Then, the image splitting portion 32B displays the split images in corresponding areas of the liquid crystal panel 34.

A specific example will be described. In the state j1, the image splitting portion 32B splits the image such that a tab image and the image of the called telephone number (including symbol image) are selected as an image for near view g102E, and the rest of the images are selected as an image for intermediate view g104E. Moreover, the image splitting portion 32B assigns a black image to an image for distant view g106E. Then, the image splitting portion 32B converts the area except for the image for near view g102E into a black image, and converts the area except for the image for intermediate view g104E into a black image. Thus, a no display area g101, the near view image g102E, a no display area g103, the intermediate view image g104E, a no display area g105, the distant view image g106E (black image), and a no display area g107 are displayed on the liquid crystal panel 34, as shown in the image g100Eⱼ₁.

A virtual image g200Eⱼ₁ is an example of a virtual image in the state j1.

A near view virtual image g202Eⱼ₁ is a virtual image based on the near view image g102E, and is formed closest to the plane of projection 50. A distant view virtual image g206Eⱼ₁ is a virtual image based on the distant view image g106E, and is formed farthest from the plane of projection 50, among the near view virtual image g202Eⱼ₁, intermediate view virtual image g204Eⱼ₁, and distant view virtual image g206Eⱼ₁. The intermediate view virtual image g204Eⱼ₁ is a virtual image based on the intermediate view image g104E, and is formed between the near view virtual image g202Eⱼ₁ and the distant view virtual image g206Eⱼ₁.

An image g300Eⱼ₁ is an example of an image viewed by the driver, in which the near view virtual image g202Eⱼ₁, intermediate view virtual image g204Eⱼ₁, and distant view virtual image g206Eⱼ₁ are superimposed on one another.

In the state j1, the image splitting portion 32B enlarges the character size of the selected image of the called telephone number, and performs splitting so that the selected image is the image for near view, which is the image closest to the driver. Also in the state j1, the image splitting portion 32B does not change the character size of the rest of the images, and performs splitting so that the rest of the images are the image for intermediate view. This allows the selected image of the called telephone number to be displayed in the foremost position, and be more recognizable to the driver.

In the state j2, the image splitting portion 32B performs splitting so that the image of the name of the person from which a call has been received is the image for near view, and the rest is the image for intermediate view, and also assigns a black image to the image for distant view. This allows the selected image of the name of the person from which a call has been received to be displayed in the foremost position, and be more recognizable to the driver.

In the state j3, the image splitting portion 32B performs splitting so that the image of the name of the person to which a return call has been made is the image for near view, and the rest is an image for intermediate view, and also assigns a black image to the image for distant view. This allows the selected image of the name of the person to which a return call has been made to be displayed in the foremost position, and be more recognizable to the driver.

As has been described, in the display device for a vehicle of the embodiment, the near side split design (near view image g102E) is a partial design selected by the driver from among the multiple split designs.

According to the embodiment configured in this manner, the image of a part selected by the driver can be displayed in the foremost position, and therefore the part selected by the driver can be displayed in an accentuated manner.

Note that a single continuous design may be split into two, four, or more in the second and third embodiments as well.

Also, although the first to third embodiments describe an example where a single continuous display image is split horizontally, the display image may be split vertically, or be split for certain areas instead.

Also, although the embodiments describe an example where the image is provided to the driver (observer), the image may be provided to an occupant sitting in a passenger's seat, or to an occupant sitting in a back seat instead.

### Other Examples

FIG. 15 described an example of how an image of a telephone book is split into three, to accentuate a part selected by the driver.

Hereinbelow, a description will be given of an example where a warning is displayed on three split areas of the liquid crystal panel 34. Note that although the description will be given by using the configuration of the display device for a vehicle 1, the configuration of the display device for a vehicle 1A or 1B may be used instead.

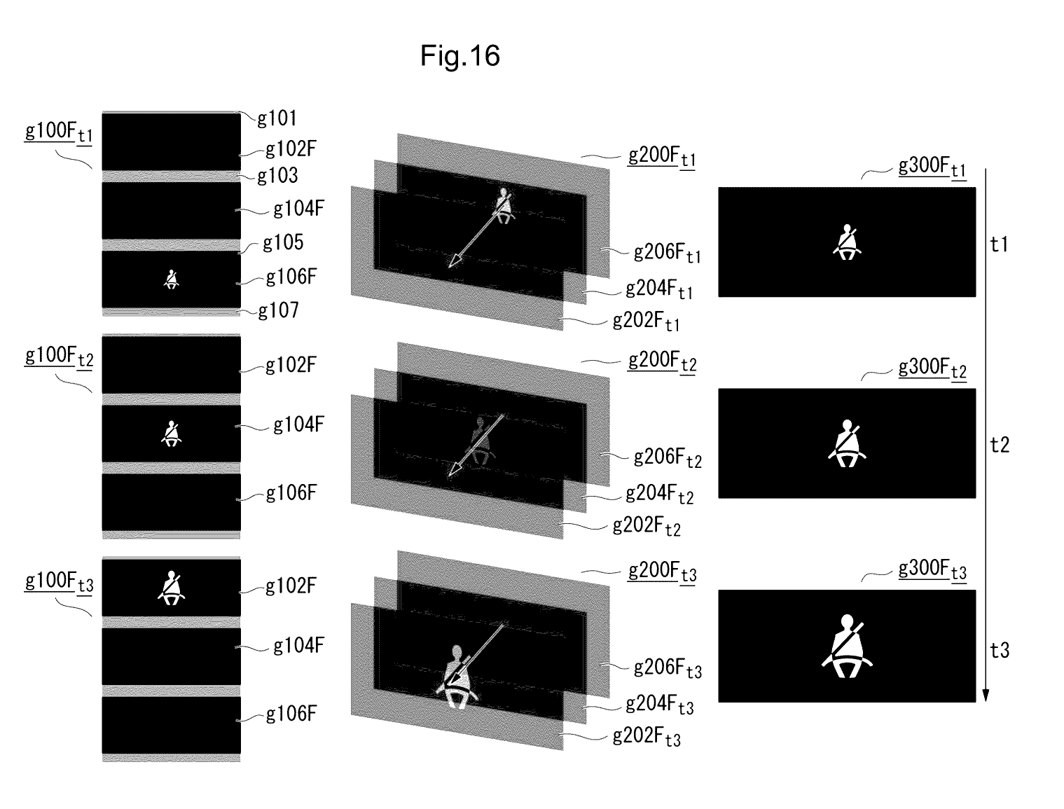

FIG. 16 is a diagram showing an example of how a warning is displayed in three split areas of the liquid crystal panel 34, according to the embodiment. The example shown in FIG. 16 is a case of displaying a warning when the seat belt is not fastened.

As shown in FIG. 16, at time t1, the image splitting portion 32B selects a display image outputted by the image output device 10 as the distant view image g106F, and assigns a black image to the near view image g102F and intermediate view image g104F. With this, a virtual image g200Fₜ₁ (near view virtual image g202Fₜ₁, intermediate view virtual image g204Fₜ₁, and distant view virtual image g206Fₜ₁) is formed, and the driver views an image g300Fₜ₁ based on the virtual image g200Fₜ₁.

At time t2, the image splitting portion 32B selects a display image outputted by the image output device 10 as the intermediate view image g104F, and assigns a black image to the near view image g102F and distant view image g106F. With this, a virtual image g200Fₜ₂ (near view virtual image g202Fₜ₂, intermediate view virtual image g204Fₜ₂, and distant view virtual image g206Fₜ₂) is formed, and the driver views an image g300Fₜ₂ based on the virtual image g200Fₜ₂.

At time t3, the image splitting portion 32B selects a display image outputted by the image output device 10 as the near view image g102F, and assigns a black image to the intermediate view image g104F and distant view image g106F. With this, a virtual image g200Fₜ₃ (near view virtual image g202Fₜ₃, intermediate view virtual image g204Fₜ₃, and distant view virtual image g206Fₜ₃) is formed, and the driver views an image g300Fₜ₃ based on the virtual image g200Fₜ₃.

Thus, through time t1 to t3, the driver views a warning image for prompting fastening of the seatbelt, which appears as if it is gradually coming closer from the far side. By viewing such an image, the driver is more likely to notice the warning for prompting fastening of the seatbelt, as compared to a warning such as a lamp of the conventional technique.

Note that a program for implementing functions of the display device for a vehicle 1, 1A, and 1B of the present invention may be recorded in a computer readable recording medium, and the program recorded in the recording medium may be read and executed by a computer system, to output and split a display image, for example. Note that the term “computer system” here includes an OS and hardware such as peripheral devices. Also, “computer system” includes a WW system having an environment that can provide (or display) websites. Additionally, “computer readable recording medium” refers to a transportable medium such as a flexible disk, a magneto-optical disk, a ROM, and a CD-ROM, and also a storage device such as a hard disk built into a computer system. Further, “computer readable recording medium” includes those that retain a program for a certain time period, such as a volatile memory (RAM) inside a computer system serving as a server or a client when the program is transmitted through a network such as the Internet, or a communication line such as a telephone line.

Also, the above program may be transmitted from a computer system having the program stored in a storage device, for example, to another computer system, through a transmission medium or by a carrier wave in the transmission medium. Here, the “transmission medium” for transmitting the program refers to a medium having a function of transmitting information, like a network (communication network) such as the Internet, and a communication line (communication wire) such as a telephone line. Also, the above program may implement a part of the function described above. Furthermore, the program may be a so-called difference file (difference program), which can implement the aforementioned function by being combined with a program prestored in a computer system.

### DESCRIPTION OF REFERENCE NUMERALS

1, 1A, 1B . . . display device for a vehicle, 10, 10B . . . image output device, 20 . . . operation portion, 30, 30A, 30B . . . design display portion, 32, 32A, 32B . . . image splitting portion, 34 . . . liquid crystal panel, 40 . . . virtual image display parts, 42 . . . mirror, 44 . . . second semitransparent mirror, 46 . . . first semitransparent mirror, 50 . . . plane of projection, 342 . . . first display area, 344 . . . second display area, 346 . . . third display area, g102, g102A, g102B, g102C, g102D, g102E . . . near view image, g104, g104A, g104B, g104C, g104D, g104E . . . intermediate view image, g106, g106A, g106B, g106C, g106D, g106E . . . distant view image, g200, g200B, g200C, g200Dₜ₁-g200Dₜ₄, g200Eⱼ₁-g200Eⱼ₃, g200Fₜ₁-g200Fₜ₃ . . . virtual image, g202, g202B, g202C, g202Dₜ₁-g202Dₜ₄, g202Eⱼ₁-g202Eⱼ₃, g202Fₜ₁-g202Fₜ₃ . . . near view virtual image, g204, g204B, g204C, g204Dₜ₁-g204Dₜ₄, g204Eⱼ₁-g204Eⱼ₃, g204Fₜ₁-g204Fₜ₃ . . . intermediate view virtual image, g206, g206B, g206C, g206Dₜ₁-g206Dₜ₄, g206Eⱼ₁-g206Eⱼ₃, g206Fₜ₁-g206Fₜ₃ . . . distant view virtual image

1. A display device for a vehicle comprising:
a plane of projection on which a virtual image of a predetermined design is to be projected in a vehicle so as to be displayed to a driver in a sight line direction which is in a view from the driver to the plane of projection;
a design display device configured to divide the predetermined design into a plurality of split designs, thereby generating a plurality of virtual images respectively including the split designs, the plurality of virtual images comprising an image of a near side split design and an image of a far side split design which is designed to look more distant than the near side split design in the sight line direction; and
a plurality of virtual image display parts configured to respectively project the virtual images of the corresponding split designs on the plane of projection such that the projected virtual images compose the virtual image of the predetermined design in a view from the driver, wherein
the plurality of virtual image display parts project the image of the far side split design from a far side in the sight line direction and the image of the near side split design from a near side closer to the driver than the far side in the sight line direction so as to be displayed on the plane of projection as if the near side split design continues into the far side split design from the near side to the far side in the sight line direction.

2. The display device for a vehicle according to claim 1, wherein:
said plurality of split designs include n (n is two or a larger integer) split designs;
said design display device includes a liquid crystal display having n display areas;
said near side split design is displayed in a first display area of said n display areas; and
said far side split design is displayed in an n-th display area of said n display areas.

3. The display device for a vehicle according to claim 2, wherein:
said plurality of virtual image display parts include a single mirror and (n−1) semitransparent mirrors;
said mirror reflects said far side split design displayed in said n-th display area; and
a first semitransparent mirror, which is closest to the plane of projection on which said plurality of split designs are projected among said (n−1) semitransparent mirrors, transmits said far side split design reflected by said mirror, and reflects said near side split design displayed in said first display area, to project the images on said plane of projection.

4. The display device for a vehicle according to claim 1, wherein:
said plurality of split designs include first to third split designs;
said design display device includes a liquid crystal display having first to third display areas;
said near side split design as the first split design is displayed in the first display area;
said far side split design as the third split design is displayed in the third display area;
an intermediate split design as the second split design, which is a split design between said near side split design and said far side split design, is displayed in the second display area;
said plurality of virtual image display parts include a mirror, a first semitransparent mirror, and a second semitransparent mirror;
said first semitransparent mirror, said second semitransparent mirror, and said mirror are arranged in this order from the side closer to the plane of projection on which said plurality of split designs are projected;
said mirror reflects said far side split design displayed in said third display area;
said second semitransparent mirror transmits said far side split design reflected by said mirror, and reflects said intermediate split design displayed in said second display area; and
said first semitransparent mirror transmits said far side split design transmitted by said second semitransparent mirror and said intermediate split design reflected by said second semitransparent mirror, and reflects said near side split design displayed in said third display area, to project the images on said plane of projection.

5. The display device for a vehicle according to claim 1, wherein
said plurality of split designs do not have a line continuous between adjacent split designs.

6. The display device for a vehicle according to claim 1, wherein
said nearside split design is a partial design selected by the driver from among said plurality of split designs.

7. A method for displaying a virtual image of a predetermined design to a driver in a sight line direction which is in a view from the driver to a plane of projection by projecting the image on the plane of projection in a vehicle, the method comprising:
an image generation step of, performed by a design display device, dividing the predetermined design to be displayed into a plurality of split designs, thereby generating a plurality of virtual images respectively including the split designs, the plurality of virtual images comprising an image of a near side split design and an image of a far side split design which is designed to look more distant than the near side split in the sight line direction; and
a virtual image display step of, performed by a plurality of virtual image display parts, respectively projecting the virtual images of the corresponding split designs to the plane of projection such that the projected virtual images compose the virtual image of the predetermined design in the view from the driver, wherein
the plurality of virtual image display parts project the image of the far side split design from a far side in the sight line direction and the image of the near side split design from a near side closer to the driver than the far side in the sight line direction so as to be displayed on the plane of projection as if the near side split design continues into the far side split design from the near side to the far side in the sight line direction.
